(19) United States
(12) Patent Application Publication
(10) Pub. No.: US 2026/0135488 A1
(43) Pub. Date: May 14, 2026

(54) BOOST CONVERSION CIRCUIT

(71) Applicant: Xiamen PVTECH Co., Ltd., Xiamen (CN)

(72) Inventors: RONGTU LIU, Xiamen (CN); CHUNMING LIU, Xiamen (CN); XIANG CHEN, Xiamen (CN); FUXING LU, Xiamen (CN)

(21) Appl. No.: 19/370,641

(22) Filed: Oct. 27, 2025

(30) Foreign Application Priority Data
Nov. 12, 2024 (CN) 202411612960.3

(51) Int. Cl. H02M 3/20; H02M 3/156; H02M 3/18; H05B 45/38

(52) U.S. Cl. CPC H02M 3/20; H02M 3/156; H02M 3/18; H05B 45/38

(57) ABSTRACT

A boost conversion circuit includes a switch, a first diode, a first inductor, a first capacitor, a first energy storage module and a second energy storage module. When the switch is turned on, a voltage source charges the first inductor, the first capacitor, and the second energy storage module. When the switch is turned off, the second energy storage module charges the first energy storage module, and the load is simultaneously driven by the first capacitor and the first energy storage module. Via the above circuit operation mechanism, the first capacitor and the first energy storage module can drive a load requiring a high driving voltage, such that the load can achieve higher power.

### TECHNICAL FIELD

The disclosure relates to a circuit design, in particular to the circuit design of a boost conversion circuit.

### BACKGROUND

Buck converters have been widely applied in various electronic products and lighting devices, making their applications extensive and their usage highly flexible.

However, because the current of high-frequency electronic ballasts is fixed, LED lighting devices using buck converters exhibit a significant power difference between the utility power mode and electronic ballast mode, resulting in a substantial difference in luminous flux. Due to the limitations of the circuit design of currently available converters, this problem cannot be effectively resolved.

### SUMMARY

One embodiment of the disclosure provides a boost conversion circuit, which includes a switch, a first diode, a first inductor, a first capacitor, a first energy storage module and a second energy storage module. The first end and second end of the switch are respectively connected to the positive electrode of a voltage source and a first node. The first node is connected to the positive electrode of a load. The negative electrode and positive electrode of the first diode are respectively connected to the first node and a second node. The second node is connected to the negative electrode of the voltage source. The first end and second end of the first inductor are respectively connected to the second node and a third node. The first end and second end of the first capacitor are respectively connected to the first node and third node. The first end and second end of the first energy storage module are respectively connected to the third node and a fourth node. The fourth node is connected to the negative electrode of the load. The first end and second end of the second energy storage module are respectively connected to the third node and the fourth node.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a circuit diagram of a boost conversion circuit in accordance with a first embodiment of the disclosure.

FIG. 2 is a circuit diagram of a boost conversion circuit in accordance with a second embodiment of the disclosure.

FIG. 3 is a circuit diagram of a boost conversion circuit in accordance with a third embodiment of the disclosure.

FIG. 4 is a first schematic view of an operating state of the boost conversion circuit in accordance with the third embodiment of the disclosure.

FIG. 5 is a second schematic view of the operating state of the boost conversion circuit in accordance with the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

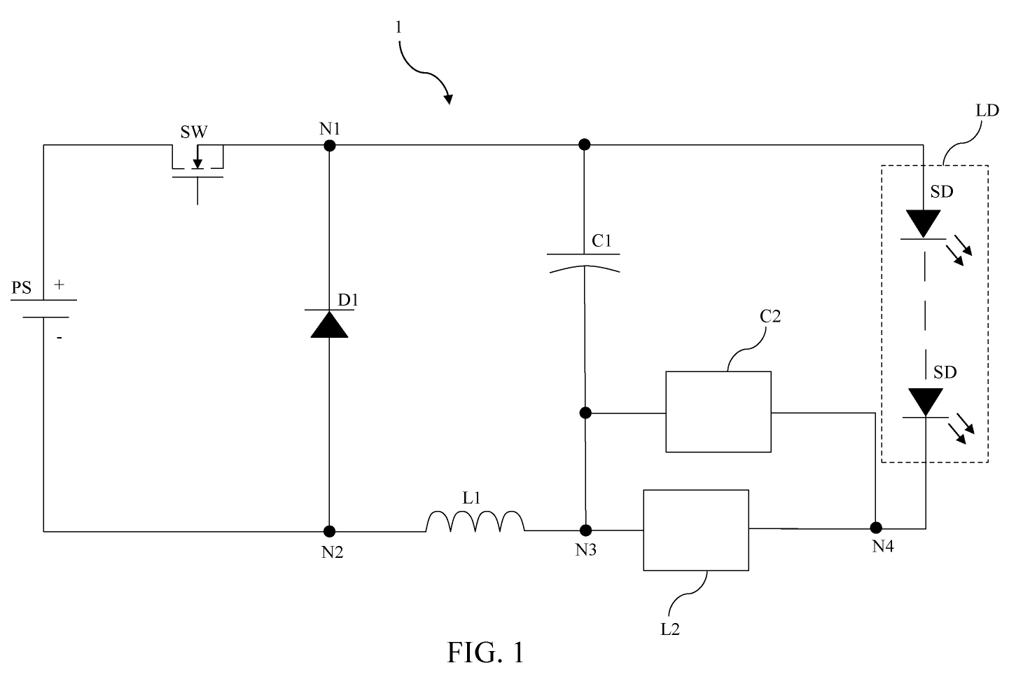

Please refer to FIG. 1, which is a circuit diagram of a boost conversion circuit in accordance with a first embodiment of the disclosure. As shown in FIG. 1, the boost conversion circuit 1 includes a switch SW, a first diode D1, a first inductor L1, a first capacitor C1, a first energy storage module C2, and a second energy storage module L2.

The first end and second end of the switch SW are respectively connected to the positive electrode of a voltage source PS and a first node N1. In this embodiment, the switch SW may be a metal-oxide-semiconductor field-effect transistor (MOSFET). In another embodiment, the switch SW may be a bipolar junction transistor (BJT) or other similar components. The first node N1 is connected to the positive electrode of a load LD. In this embodiment, the load LD may include a plurality of LEDs SD connected in series. In one embodiment, the load LD may also be formed based on series and/or parallel circuits.

The negative electrode of the first diode D1 is connected to the first node N1, and the positive electrode of the first diode D1 is connected to a second node N2. The second node N2 is connected to the negative electrode of the voltage source PS. The voltage source PS may be a direct current source, such as a primary battery, rechargeable battery, switching power supply, adapter, or the like.

The first end of the first inductor L1 is connected to the second node N2, and the second end thereof is connected to a third node N3.

The first end of the first capacitor C1 is connected to the first node N1, and the second end thereof is connected to the third node N3.

The first end of the first energy storage module C2 is connected to the third node N3, and the second end thereof is connected to a fourth node N4. The fourth node N4 is connected to the negative electrode of the load LD. In one embodiment, the first energy storage module C2 may be a capacitor. In another embodiment, the first energy storage module C2 may be another component with energy storage function.

The first end of the second energy storage module L2 is connected to the third node N3, and the second end thereof is connected to the fourth node N4. In one embodiment, the second energy storage module L2 may be an inductor. In another embodiment, the second energy storage module L2 may be another component with energy storage function.

When the switch SW is turned on, the voltage source PS charges the first inductor L1, first capacitor C1, and second energy storage module L2. When the switch SW is turned off, the second energy storage module L2 charges the first energy storage module C2. Then, the first capacitor C1 and first energy storage module C2 can simultaneously drive the load LD.

Through the above circuit operation mechanism, the first capacitor C1 and first energy storage module C2 can drive the load LD that requires a high driving voltage, allowing the load LD to achieve higher power. Therefore, the boost conversion circuit 1 can be more comprehensive in applications and meet actual requirements.

The embodiment just exemplifies the disclosure and is not intended to limit the scope of the disclosure; any equivalent modification and variation according to the spirit of the disclosure is to be also included within the scope of the following claims and their equivalents.

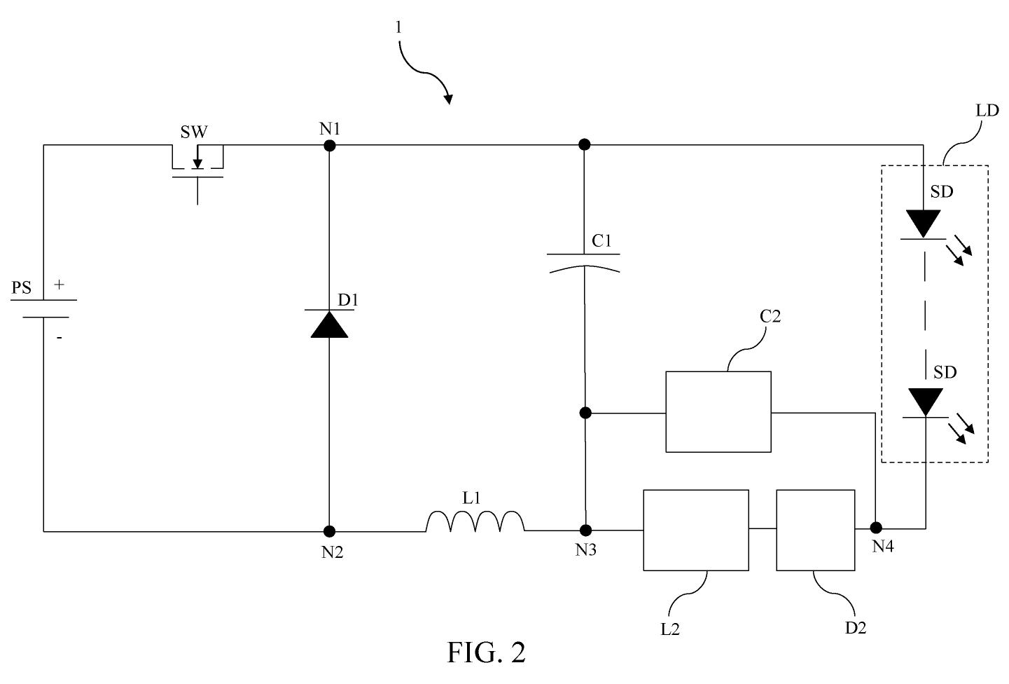

Please refer to FIG. 2, which is a circuit diagram of a boost conversion circuit in accordance with a second embodiment of the disclosure. As shown in FIG. 2, the boost conversion circuit 1 includes a switch SW, a first diode D1, a first inductor L1, a first capacitor C1, a first energy storage module C2, and a second energy storage module L2. The difference between this embodiment and the previous embodiment is that the boost conversion circuit 1 of this embodiment further includes a rectification module D2. In one embodiment, the rectification module D2 may be a diode. In another embodiment, the rectification module D2 may also be other circuits with current-limiting function.

The first end and second end of the switch SW are respectively connected to the positive electrode of a voltage source PS and a first node N1.

The negative electrode of the first diode D1 is connected to the first node N1, and the positive electrode of the first diode D1 is connected to a second node N2. The second node N2 is connected to the negative electrode of the voltage source PS.

The first end of the first inductor L1 is connected to the second node N2, and the second end thereof is connected to the third node N3.

The first end of the first capacitor C1 is connected to the first node N1, and the second end thereof is connected to a third node N3.

The first end of the first energy storage module C2 is connected to the third node N3, and the second end thereof is connected to a fourth node N4. The fourth node N4 is connected to the negative electrode of the load LD.

The first end of the second energy storage module L2 is connected to the third node N3, and the second end thereof is connected to the fourth node N4 via the rectification module D2.

When the switch SW is turned on, the voltage source PS charges the first inductor L1, first capacitor C1, and second energy storage module L2. When the switch SW is turned off, the first energy storage module C2, second energy storage module L2, and rectification module D2 form a loop, allowing the second energy storage module L2 to charge the first energy storage module C2. The rectification module D2 can restrict the current direction to ensure the proper operation of the charging loop from the second energy storage module L2 to the first energy storage module C2. Then, the first capacitor C1 and first energy storage module C2 can simultaneously drive the load LD.

Through the above circuit operation mechanism, the first capacitor C1 and first energy storage module C2 can drive the load LD that requires a high driving voltage, allowing the load LD to achieve higher power. Therefore, the boost conversion circuit 1 can be more comprehensive in applications and meet actual requirements.

The embodiment just exemplifies the disclosure and is not intended to limit the scope of the disclosure; any equivalent modification and variation according to the spirit of the disclosure is to be also included within the scope of the following claims and their equivalents.

It is worthy to point out that since the current of high-frequency electronic ballasts is fixed, LED lighting devices using buck converters exhibit a significant power difference between the utility power mode and electronic ballast mode, resulting in a substantial difference in luminous flux. Due to the limitations of the circuit design of currently available converters, this problem cannot be effectively resolved. By contrast, according to one embodiment of the present invention, the boost conversion circuit 1 includes a switch SW, a first diode D1, a first inductor L1, a first capacitor C1, a first energy storage module C2, and a second energy storage module L2. The first end and second end of the switch SW are respectively connected to the positive electrode of the voltage source and a first node N1. The first node N1 is connected to the positive electrode of a load LD. The negative and positive electrodes of the first diode D1 are respectively connected to the first node N1 and a second node N2. The second node N2 is connected to the negative electrode of the voltage source. The first and second ends of the first inductor L1 are respectively connected to the second node N2 and a third node N3. The first and second ends of first capacitor C1 are respectively connected to the first node N1 and third node N3. The first and second ends of the first energy storage module C2 are respectively connected to the third node N3 and a fourth node N4. The fourth node N4 is connected to the negative electrode of the load LD. The first and second ends of second energy storage module L2 are respectively connected to the third node N3 and fourth node N4. When the switch SW is turned on, the voltage source charges the first inductor L1, first capacitor C1, and second energy storage module L2. When the switch SW is turned off, the second energy storage module L2 charges the first energy storage module C2, and the first capacitor C1 together with first energy storage module C2 simultaneously drives the load LD. Via this circuit operation mechanism, the first capacitor C1 and first energy storage module C2 can drive the load LD requiring high driving voltage, such that the load LD can achieve higher power. Therefore, the boost conversion circuit 1 can be more comprehensive in application and can meet actual requirements.

Also, according to one embodiment of the present invention, the boost conversion circuit 1 can drive the load LD at the voltage close to the voltage (RMS value) of the utility power. Therefore, the luminous flux of the load LD in the electronic ballast mode can approach or exceed that in the utility power mode. Accordingly, the boost conversion circuit 1 can achieve high efficiency and meet actual requirements.

Further, according to one embodiment of the present invention, the boost conversion circuit 1 can drive the load LD at the voltage close to the voltage (RMS value) of the utility power. Therefore, the luminous flux of the load LD in the electronic ballast mode can approach or exceed that in the utility power mode. As a result, fewer LED lighting devices using this boost conversion circuit 1 can replace more currently available LED lighting devices. Therefore, the boost conversion circuit 1 can be more flexible in use.

Moreover, according to one embodiment of the present invention, the boost conversion circuit 1 further includes a rectification module D2. The second end of the second energy storage module L2 is connected to the fourth node N4 via the rectification module D2. The rectification module D2 can restrict the current direction to ensure the proper operation of the charging loop from the second energy storage module L2 to the first energy storage module C2. Accordingly, this circuit design enhances the operational stability of the boost conversion circuit 1, such that the boost conversion circuit 1 can achieve the desired technical effects.

Furthermore, according to one embodiment of the present invention, the boost conversion circuit 1 has a simple design, so the boost conversion circuit 1 can achieve the desired technical effects without significantly increasing the cost thereof. Therefore, the boost conversion circuit 1 can achieve higher practicality and meet the requirements of different applications. As described above, the boost conversion circuit 1 according to the embodiments of the disclosure can definitely achieve great technical effects.

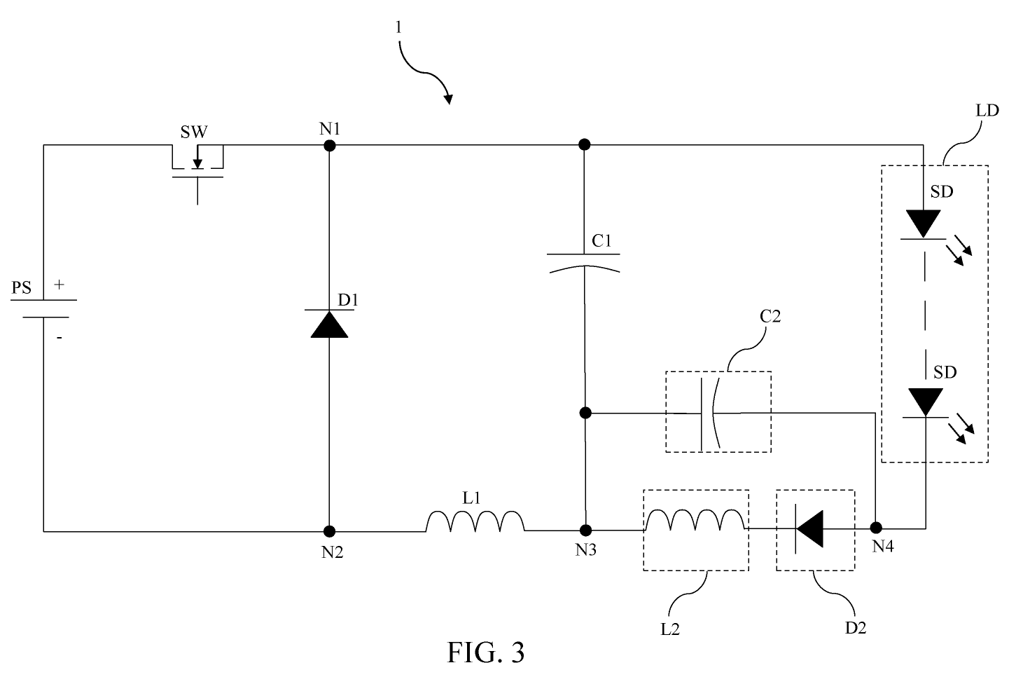

Please refer to FIG. 3, which is a circuit diagram of a boost conversion circuit in accordance with a third embodiment of the disclosure. As shown in FIG. 3, the boost conversion circuit 1 includes a switch SW, a first diode D1, a first inductor L1, a first capacitor C1, a first energy storage module C2, a second energy storage module L2, and a rectification module D2.

The first end and second end of the switch SW are respectively connected to the positive electrode of a voltage source PS and a first node N1.

The negative electrode of the first diode D1 is connected to the first node N1, and the positive electrode of the first diode D1 is connected to a second node N2. The second node N2 is connected to the negative electrode of the voltage source PS.

The first end of the first inductor L1 is connected to second node N2, and the second end thereof is connected to a third node N3.

The first end of the first capacitor C1 is connected to the first node N1, and the second end thereof is connected to the third node N3.

The first end of the first energy storage module C2 is connected to the third node N3, and the second end thereof is connected to a fourth node N4. In this embodiment, the first energy storage module C2 is a second capacitor. The fourth node N4 is connected to the negative electrode of a load LD.

The first end of the second energy storage module L2 is connected to the third node N3, and the second end thereof is connected to the fourth node N4 via the rectification module D2. In this embodiment, the second energy storage module L2 is a second inductor. In this embodiment, the rectification module D2 is a second diode.

The embodiment just exemplifies the disclosure and is not intended to limit the scope of the disclosure; any equivalent modification and variation according to the spirit of the disclosure is to be also included within the scope of the following claims and their equivalents.

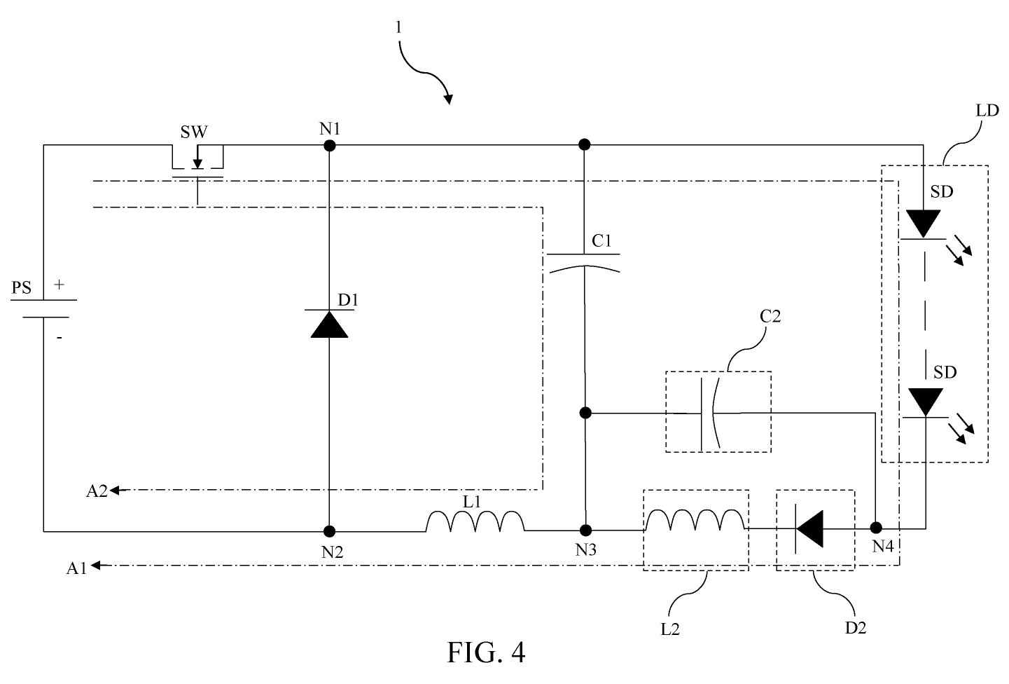

Please refer to FIG. 4, which is a first schematic view of an operating state of the boost conversion circuit in accordance with the third embodiment of the disclosure. As shown in FIG. 4, when the switch SW is turned on, the voltage source PS charges the first inductor L1, first capacitor C1, and second energy storage module L2, with the current directions indicated by the arrows A1 and A2 in FIG. 4. At this time, although current passes through load LD, the voltage is not sufficient to drive the load LD.

The embodiment just exemplifies the disclosure and is not intended to limit the scope of the disclosure; any equivalent modification and variation according to the spirit of the disclosure is to be also included within the scope of the following claims and their equivalents.

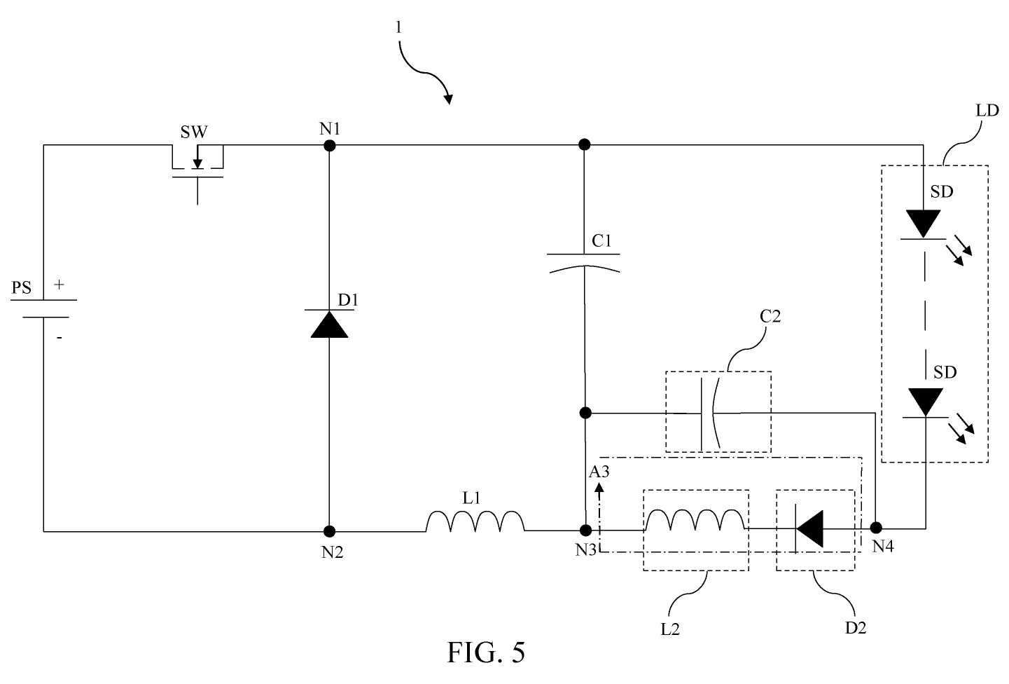

Please refer to FIG. 5, which is a second schematic view of the operating state of the boost conversion circuit in accordance with the third embodiment of the disclosure. As shown in FIG. 5, when the switch SW is turned off, the first energy storage module C2, second energy storage module L2, and rectification module D2 form a loop, allowing the second energy storage module L2 to charge the first energy storage module C2, with current direction indicated by arrow A3 in FIG. 5. The first inductor L1 and second energy storage module L2 have characteristics resisting changes in current. The rectification module D2 can restrict the current direction to ensure the proper operation of the charging loop from the second energy storage module L2 to the first energy storage module C2. Then, the first capacitor C1 and first energy storage module C2 can simultaneously drive the load LD. At this time, the first diode D1, load LD, rectification module D2, second energy storage module L2, and first inductor L1 form a loop to drive the load LD. For example, the first capacitor C1 may charge to about 60V to 70V (V1), and the first energy storage module C2 may charge to about 30V (V2); the voltage values are provided for illustration only. Therefore, the load LD can receive approximately 90V to 100V (V1+V2) driving voltage.

Through the above circuit operation mechanism, the first capacitor C1 and first energy storage module C2 can drive the load LD that requires a high driving voltage, allowing the load LD to achieve higher power, thereby matching the power under the electronic ballast mode with that under the utility power mode. Therefore, the boost conversion circuit 1 can be more comprehensive in application and meet actual requirements.

Additionally, in this embodiment, the boost conversion circuit 1 can drive the load LD at a driving voltage close to the voltage (RMS value) of the utility power. Therefore, the luminous flux of the load LD in the electronic ballast mode can approach or exceed the luminous flux of the load LD in the utility power mode. Therefore, the boost conversion circuit 1 can achieve high efficiency and meet actual requirements.

Furthermore, in this embodiment, the boost conversion circuit 1 can drive the load LD at a driving voltage close to the voltage (RMS value) of the utility power. Therefore, the luminous flux of the load LD in the electronic ballast mode can approach or exceed the luminous flux of the load LD in the utility power mode. Consequently, a smaller number of LED lighting devices using this boost conversion circuit 1 can replace more currently available LED lighting devices. Thus, the boost conversion circuit 1 can be more flexible in use.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the present invention, the boost conversion circuit 1 includes a switch SW, a first diode D1, a first inductor L1, a first capacitor C1, a first energy storage module C2, and a second energy storage module L2. The first end and second end of the switch SW are respectively connected to the positive electrode of the voltage source and a first node N1. The first node N1 is connected to the positive electrode of a load LD. The negative and positive electrodes of the first diode D1 are respectively connected to the first node N1 and a second node N2. The second node N2 is connected to the negative electrode of the voltage source. The first and second ends of the first inductor L1 are respectively connected to the second node N2 and a third node N3. The first and second ends of first capacitor C1 are respectively connected to the first node N1 and third node N3. The first and second ends of the first energy storage module C2 are respectively connected to the third node N3 and a fourth node N4. The fourth node N4 is connected to the negative electrode of the load LD. The first and second ends of second energy storage module L2 are respectively connected to the third node N3 and fourth node N4. When the switch SW is turned on, the voltage source charges the first inductor L1, first capacitor C1, and second energy storage module L2. When the switch SW is turned off, the second energy storage module L2 charges the first energy storage module C2, and the first capacitor C1 together with first energy storage module C2 simultaneously drives the load LD. Via this circuit operation mechanism, the first capacitor C1 and first energy storage module C2 can drive the load LD requiring high driving voltage, such that the load LD can achieve higher power. Therefore, the boost conversion circuit 1 can be more comprehensive in application and can meet actual requirements.

Also, according to one embodiment of the present invention, the boost conversion circuit 1 can drive the load LD at the voltage close to the voltage (RMS value) of the utility power. Therefore, the luminous flux of the load LD in the electronic ballast mode can approach or exceed that in the utility power mode. Accordingly, the boost conversion circuit 1 can achieve high efficiency and meet actual requirements.

Further, according to one embodiment of the present invention, the boost conversion circuit 1 can drive the load LD at the voltage close to the voltage (RMS value) of the utility power. Therefore, the luminous flux of the load LD in the electronic ballast mode can approach or exceed that in the utility power mode. As a result, fewer LED lighting devices using this boost conversion circuit 1 can replace more currently available LED lighting devices. Therefore, the boost conversion circuit 1 can be more flexible in use.

Moreover, according to one embodiment of the present invention, the boost conversion circuit 1 further includes a rectification module D2. The second end of the second energy storage module L2 is connected to the fourth node N4 via the rectification module D2. The rectification module D2 can restrict the current direction to ensure the proper operation of the charging loop from the second energy storage module L2 to the first energy storage module C2. Accordingly, this circuit design enhances the operational stability of the boost conversion circuit 1, such that the boost conversion circuit 1 can achieve the desired technical effects.

Furthermore, according to one embodiment of the present invention, the boost conversion circuit 1 has a simple design, so the boost conversion circuit 1 can achieve the desired technical effects without significantly increasing the cost thereof. Therefore, the boost conversion circuit 1 can achieve higher practicality and meet the requirements of different applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A boost conversion circuit, comprising:
a switch, wherein a first end and a second end of the switch are respectively connected to a positive electrode of a voltage source and a first node, and the first node is connected to a positive electrode of a load;
a first diode, wherein a negative electrode and a positive electrode of the first diode are respectively connected to the first node and a second node, and the second node is connected to a negative electrode of the voltage source;
a first inductor, wherein a first end and a second end of the first inductor are respectively connected to the second node and a third node;
a first capacitor, wherein a first end and a second end of the first capacitor are respectively connected to the first node and the third node;
a first energy storage module, wherein a first end and a second end of the first energy storage module are respectively connected to the third node and a fourth node, and the fourth node is connected to a negative electrode of the load; and
a second energy storage module, wherein a first end and a second end of the second energy storage module are respectively connected to the third node and the fourth node.

2. The boost conversion circuit as claimed in claim 1, further comprising a rectification module, wherein the second end of the second energy storage module is connected to the fourth node via the rectification module.

3. The boost conversion circuit as claimed in claim 2, wherein the rectification module is a second diode, wherein a positive electrode of the second diode is connected to the fourth node, and a negative electrode of the second diode is connected to the second end of the second energy storage module.

4. The boost conversion circuit as claimed in claim 2, wherein when the switch is turned on and then turned off, the first energy storage module, the second energy storage module, and the rectification module form a loop.

5. The boost conversion circuit as claimed in claim 1, wherein the first energy storage module is a second capacitor.

6. The boost conversion circuit as claimed in claim 1, wherein the second energy storage module is a second inductor.

7. The boost conversion circuit as claimed in claim 1, wherein when the switch is turned on, the voltage source is configured to charge the first inductor, the first capacitor, and the second energy storage module.

8. The boost conversion circuit as claimed in claim 7, wherein when the switch is turned off, the second energy storage module is configured to charge the first energy storage module.

9. The boost conversion circuit as claimed in claim 8, wherein when the switch is turned off, the first capacitor and the first energy storage module are configured to simultaneously drive the load.

10. The boost conversion circuit as claimed in claim 1, wherein the load comprises a plurality of light-emitting diodes.
